(19) United States
(12) Patent Application Publication
(10) Pub. No.: US 2024/0313577 A1
(43) Pub. Date: Sep. 19, 2024

(54) WIRELESS CHARGING DEVICE

(71) Applicant: Primax Electronics Ltd., Taipei (TW)

(72) Inventor: Bo-An Chen, Taipei (TW)

(21) Appl. No.: 18/129,377

(22) Filed: Mar. 31, 2023

(30) Foreign Application Priority Data
Mar. 16, 2023 (TW) 112109769

(51) Int. Cl. H02J 50/00; H02J 50/10; H02J 50/90

(52) U.S. Cl. CPC H02J 50/005; H02J 50/10; H02J 50/90

(57) ABSTRACT

A wireless charging device includes a device body, a magnetically attractable transmitter coil structure and a lifting assembly. The device body includes a hollow portion. The magnetically attractable transmitter coil structure is disposed within the device body and aligned with the hollow portion. The magnetically attractable transmitter coil structure is movable upwardly or downwardly relative to the device body through the lifting assembly. When a to-be-charged electronic device is close to the wireless charging device, a magnetic attractive force between a magnetically attractable receiver coil structure of the to-be-charged electronic device and the magnetically attractable transmitter coil structure is generated. In response to the magnetic attractive force, the magnetically attractable transmitter coil structure is moved upwardly through the lifting assembly. Consequently, the magnetically attractable transmitter coil structure and the magnetically attractable receiver coil structure are attracted by and aligned with each other.

### FIELD OF THE INVENTION

The present invention relates to a charging device for charging a to-be-charged electronic device, and more particularly to a wireless charging device.

### BACKGROUND OF THE INVENTION

In modern societies, portable electronic devices (e.g., smart phones) have become indispensable parts in human lives. The portable electronic devices are applied in many sectors, including food, clothing, housing, transportation, education and entertainment. Generally, the portable electronic device is powered by a built-in battery. When the electricity quantity of the battery is insufficient, it is necessary to charge the battery of the portable electronic device. Consequently, the portable electronic device can be continuously operated.

Generally, portable electronic devices can be charged by using a wired charging technology or a wireless charging technology. With the advancement of the wireless charging technology, a wireless charging device has gradually become one of the standard equipment for the portable electronic devices. For wirelessly charging a portable electronic device, the portable electronic device is firstly placed on a wireless charging device. Then, a transmitter coil in the wireless charging device is enabled to emit an electromagnetic field. When a receiver coil in the portable electronic device senses the electromagnetic field, a charging current is generated according to the change of the magnetic fluxes. Consequently, the portable electronic device is charged by the charging current.

Nowadays, a portable electronic device and a compatible wireless charging device using a MagSafe magnetic attraction technology have been introduced into the market. According to the operating principles of the MagSafe magnetic attraction technology, plural magnets are disposed within the portable electronic device and the wireless charging device and arranged around the charging coils. In response to the magnetic attractive force between the corresponding magnets, the sensing coil of the portable electronic device and the transmitter coil of the wireless charging device are seamlessly and tightly attracted by and aligned with each other. Consequently, the charging efficiency is enhanced.

However, the use of the MagSafe magnetic attraction technology still has some drawbacks. For example, the wireless charging device having the MagSafe system is only able to be cooperatively used with the portable electronic device having the MagSafe system. If the portable electronic device is not equipped with the MagSafe system, the portable electronic device is incompatible with the wireless charging device having the MagSafe system.

Therefore, there is a need of providing an improved wireless charging device in order to overcome the above drawbacks.

### SUMMARY OF THE INVENTION

An object of the present invention provides a wireless charging device. The wireless charging device comprises a magnetically attractable transmitter coil structure. The magnetically attractable transmitter coil structure can be precisely attracted by and aligned with a receiver coil structure of a to-be-charged electronic device. Consequently, the charging efficiency is effectively enhanced.

The other objects and advantages of the present invention will be understood from the disclosed technical features.

In accordance with an aspect of the present invention, a wireless charging device is provided for charging a to-be-charged electronic device. The wireless charging device includes a device body, a magnetically attractable transmitter coil structure and a lifting assembly. The device body includes an upper member, a lower member and a hollow portion. The upper member and the lower member are opposed to each other. The hollow portion is formed in the upper member. The magnetically attractable transmitter coil structure is disposed within the device body and aligned with the hollow portion. The lifting assembly is disposed within the device body and located under the magnetically attractable transmitter coil structure. The magnetically attractable transmitter coil structure is movable upwardly or downwardly relative to the device body through the lifting assembly. When the to-be-charged electronic device is moved to a position close to the wireless charging device, a magnetic attractive force between a magnetically attractable receiver coil structure of the to-be-charged electronic device and the magnetically attractable transmitter coil structure is generated. In response to the magnetic attractive force, the magnetically attractable transmitter coil structure is moved upwardly through the lifting assembly. As the magnetically attractable transmitter coil structure is moved upwardly, the magnetically attractable transmitter coil structure is moved outside the device body through the hollow portion, and the magnetically attractable transmitter coil structure and the magnetically attractable receiver coil structure of the to-be-charged electronic device are attracted by and aligned with each other.

In an embodiment, the magnetically attractable transmitter coil structure has a sensing plane. After the magnetically attractable transmitter coil structure is moved upwardly through the lifting assembly and moved outside the device body through the hollow portion, there is a height difference between the sensing plane of the magnetically attractable transmitter coil structure and the upper member of the device body.

In an embodiment, after the to-be-charged electronic device is departed from the wireless charging device, the magnetically attractable transmitter coil structure and the magnetically attractable receiver coil structure are detached from each other, and the magnetically attractable transmitter coil structure is moved downwardly through the lifting assembly. As the magnetically attractable transmitter coil structure is moved downwardly, the magnetically attractable transmitter coil structurer is moved into an inner portion of the device body through the hollow portion, and the sensing plane of the magnetically attractable transmitter coil structure and the upper member of the device body are coplanar with each other.

In an embodiment, the magnetically attractable transmitter coil structure includes a transmitter coil module and a magnetic attraction module, and the magnetic attraction module is arranged around the transmitter coil module.

In an embodiment, the transmitter coil module includes a transmitter coil unit and a first bracket. The transmitter coil unit is installed on the first bracket.

In an embodiment, the magnetic attraction module includes a second bracket, a buffering pad, a magnetic element and a circuit board. The buffering pad is installed on the second bracket. The magnetic element is installed on the buffering pad. The circuit board is installed on the second bracket. The buffering pad is arranged around the circuit board.

In an embodiment, the lifting assembly includes a connection platform, a base plate and a movable supporting element. The connection platform includes a first surface and a second surface. The first surface and the second surface are opposed to each other. The connection platform is connected with the second bracket of the magnetic attraction module through the first surface. The base plate is located under the connection platform. The movable supporting element is connected between the second surface of the connection platform and the base plate.

In an embodiment, the movable supporting element is a scissors-type supporting element.

In an embodiment, the wireless charging device further includes a main board and a power input port. The main board is disposed within the device body. The power input port is disposed within the device body. A portion of the power input port is exposed outside the device body. The lifting assembly is arranged between the main board and the magnetically attractable transmitter coil structure. The main board is electrically connected with the power input port and the magnetically attractable transmitter coil structure.

From the above descriptions, the present invention provides the wireless charging device. The magnetically attractable transmitter coil structure of the wireless charging device can be moved upwardly or downwardly through the lifting assembly. Due to the structural design, the following benefits are achieved. When a to-be-charged electronic device with a magnetically attractable receiver coil structure is moved to a position close to the wireless charging device, the magnetically attractable transmitter coil structure of the wireless charging device is moved upwardly through the lifting assembly. Since the magnetically attractable transmitter coil structure of the wireless charging device and the magnetically attractable receiver coil structure of the to-be-charged electronic device are attracted by and aligned with each other, the charging efficiency is enhanced. In addition to the function of wirelessly charging the to-be-charged electronic device with the magnetically attractable receiver coil structure, the wireless charging device of the present invention has the function of wirelessly charging the to-be-charged electronic device with the general receiver coil structure. In other words, the wireless charging device of the present invention can be cooperatively used with many kinds of electronic devices. Consequently, the compatibility of the wireless charging device is enhanced.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating the appearance of a wireless charging device in a disabled state according to an embodiment of the present invention;

FIG. 2 is a schematic cross-sectional view illustrating the wireless charging device as shown in FIG. 1 and taken along a line AA;

FIG. 3 is a schematic perspective view illustrating the appearance of the wireless charging device as shown in FIG. 1 and in an enabled state;

FIG. 4 is a schematic cross-sectional view illustrating the wireless charging device as shown in FIG. 3 and taken along a line BB;

FIG. 5 is a schematic cross-sectional view illustrating a usage scenario of the wireless charging device according to the embodiment of the present invention; and

FIG. 6 is a schematic cross-sectional view illustrating another usage scenario of the wireless charging device according to the embodiment of the present invention.

### DETAILED DESCRIPTION OF THE PREFERRED EMBODIMENT

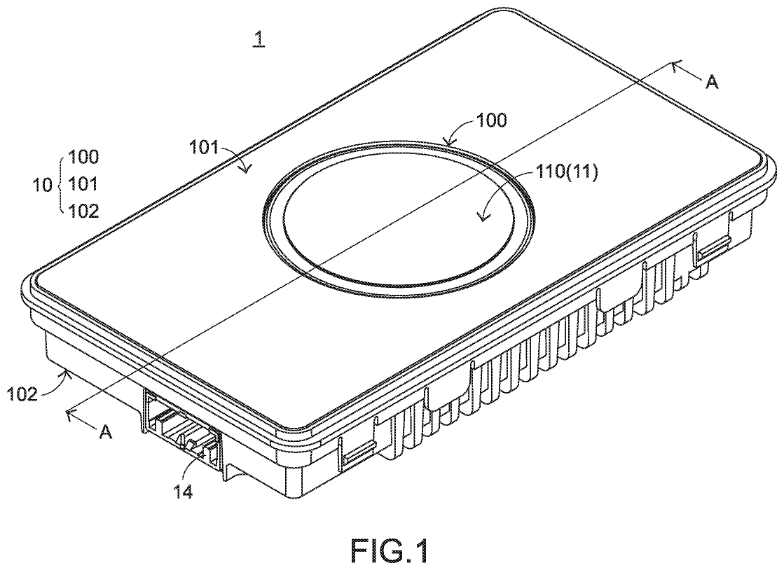

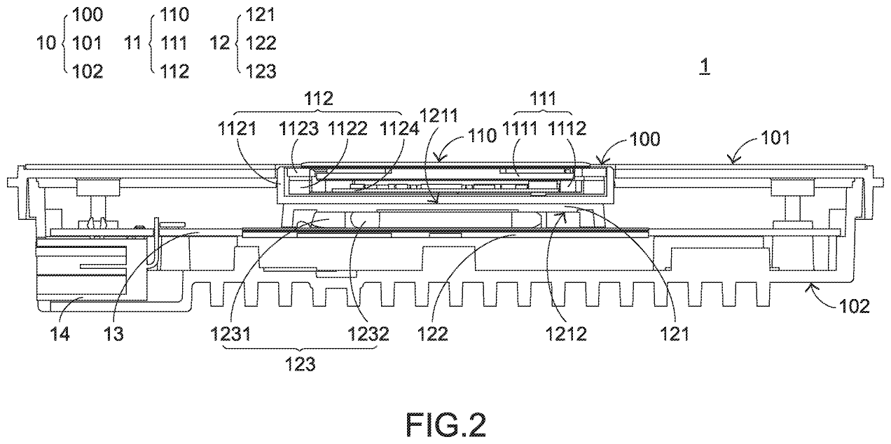

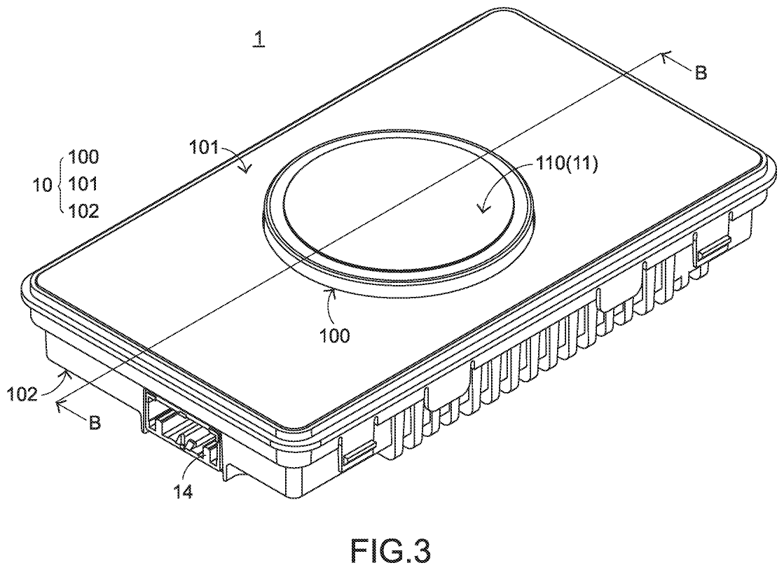

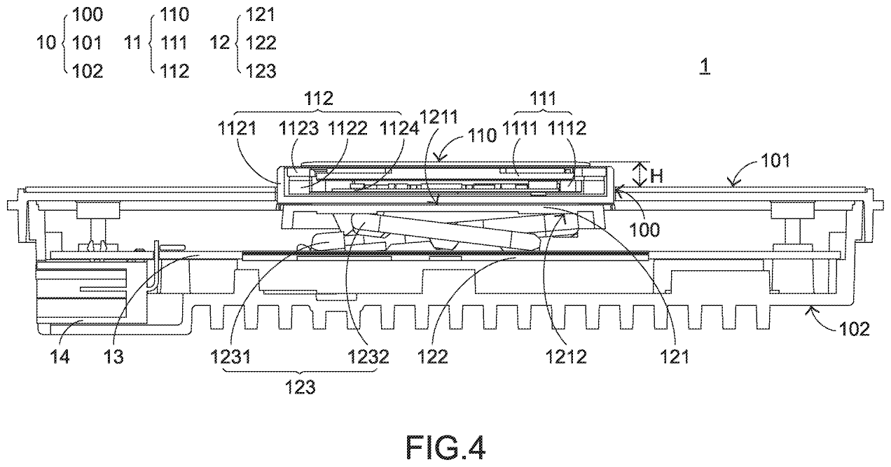

Please refer to FIGS. 1, 2, 3 and 4. FIG. 1 is a schematic perspective view illustrating the appearance of a wireless charging device in a disabled state according to an embodiment of the present invention. FIG. 2 is a schematic cross-sectional view illustrating the wireless charging device as shown in FIG. 1 and taken along a line AA. FIG. 3 is a schematic perspective view illustrating the appearance of the wireless charging device as shown in FIG. 1 and in an enabled state. FIG. 4 is a schematic cross-sectional view illustrating the wireless charging device as shown in FIG. 3 and taken along a line BB.

As shown in FIGS. 1, 2, 3 and 4, the wireless charging device 1 of this embodiment comprises a device body 10, a magnetically attractable transmitter coil structure 11 and a lifting assembly 12.

The device body 10 comprises an upper member 101, a lower member 102 and a hollow portion 100. The upper member 101 and the lower member 102 of the device body 10 are opposed to each other. The hollow portion 100 is formed in the upper member 101 of the device body 10. The magnetically attractable transmitter coil structure 11 is disposed within the device body 10. The magnetically attractable transmitter coil structure 11 is aligned with the hollow portion 100 of the device body 10. The lifting assembly 12 is disposed within the device body 10. In addition, the lifting assembly 12 is located under the magnetically attractable transmitter coil structure 11. That is, the lifting assembly 12 is arranged between the magnetically attractable transmitter coil structure 11 and the lower member 102 of the device body 10. In this embodiment, the magnetically attractable transmitter coil structure 11 is movable upwardly or downwardly relative to the device body 10 through the lifting assembly 12.

The other structure of the wireless charging device 1 will be described in more details as follows.

FIGS. 1, 2, 3 and 4 again. In an embodiment, the magnetically attractable transmitter coil structure 11 comprises a transmitter coil module 111 and a magnetic attraction module 112. The magnetic attraction module 112 is located at the outer portion of the transmitter coil module 111. That is, the magnetic attraction module 112 is arranged around the transmitter coil module 111.

Please refer to FIGS. 2, 3 and 4 again. In an embodiment, the transmitter coil module 111 comprises a transmitter coil unit 1111 and a first bracket 1112. The transmitter coil unit 1111 is installed on the first bracket 1112. During the operation of the wireless charging device 1, the transmitter coil unit 1111 emits an electromagnetic field. When a built-in receiver coil of a to-be-charged electronic device (not shown) senses the electromagnetic field, a charging current is generated according to the change of the magnetic fluxes. Consequently, the to-be-charged electronic device is charged by the charging current. The principles of wirelessly charging the to-be-charged electronic device by the wireless charging device I are well known to those skilled in the art, and not redundantly described herein.

Please refer to FIGS. 2, 3 and 4 again. In this embodiment, the magnetic attraction module 112 comprises a second bracket 1121, a buffering pad 1122, a magnetic element 1123 and a circuit board 1124. The buffering pad 1122 is installed on the second bracket 1121. The magnetic element 1123 is installed on the buffering pad 1122. That is, the buffering pad 1122 is arranged between the magnetic element 1123 and the second bracket 1121. The circuit board 1124 is installed on the second bracket 1121. In an embodiment, the circuit board 1124 is located at a middle region of the second bracket 1121, and the buffering pad 1122 and the magnetic element 1123 on the buffering pad 1122 are installed on the second bracket 1121 along the outer periphery region of the circuit board 1124. That is, the buffering pad 1122 and the magnetic element 1123 are arranged around the circuit board 1124.

Please refer to FIGS. 2, 3 and 4 again. In this embodiment, the lifting assembly 12 comprises a connection platform 121, a base plate 122 and a movable supporting element 123. The connection platform 121 comprises a first surface 1211 and a second surface 1212. The first surface 1211 and the second surface 1212 are opposed to each other. The connection platform 121 is connected with the magnetically attractable transmitter coil structure 11 through the first surface 1211. Especially, the first surface 1211 of the connection platform 121 and the second bracket 1121 of the magnetic attraction module 112 are fixed on each other. The base plate 122 is located under the connection platform 121. The movable supporting element 123 is connected between the second surface 1212 of the connection platform 121 and the base plate 122. Preferably but not exclusively, the first surface 1211 of the connection platform 121 and the second bracket 1121 of the magnetic attraction module 112 are fixed on each other through a gluing means, a welding means or any other appropriate connecting means.

In an embodiment, the movable supporting element 123 of the lifting assembly 12 is a scissors-type supporting element. It is noted that the example of the movable supporting element 123 is not restricted. That is, the structure of the movable supporting element 123 may be varied according to the practical requirements. In an embodiment, the scissors-type supporting element comprises an outer frame 1231 and an inner frame 1232. The first end of the outer frame 1231 is pivotally coupled to a first side of the second surface 1212 of the connection platform 121. The second end of the outer frame 1231 is pivotally coupled to a second side of the base plate 122. The first end of the inner frame 1232 is pivotally coupled to a second side of the second surface 1212 of the connection platform 121. The second end of the inner frame 1232 is pivotally coupled to a first side of the base plate 122. While the lifting assembly 12 is moved upwardly or downwardly, the outer frame 1231 and the inner frame 1232 are swung relative to each other.

Please refer to FIGS. 2, 3 and 4 again. In this embodiment, the wireless charging device 1 further comprises a main board 13 and a power input port 14. The main board 13 is disposed within the device body 10. The power input port 14 is disposed within the device body 10, and a portion of the power input port 14 is exposed outside the device body 10. In this embodiment, the lifting assembly 12 is arranged between the main board 13 and the magnetically attractable transmitter coil structure 11. In addition, the main board 13 is electrically connected with the power input port 14 and the magnetically attractable transmitter coil structure 11.

In this embodiment, the power input port 14 is a USB socket or a MINI USB socket. It is noted that the type and the specification of the power input port 14 are not restricted. A power cable with a USB plug or a MINI USB plug can be coupled with the power input port 14. The wireless charging device I can be coupled with an external power source (not shown) through the power cable.

The operations of the wireless charging device 1 will be described in more details as follows.

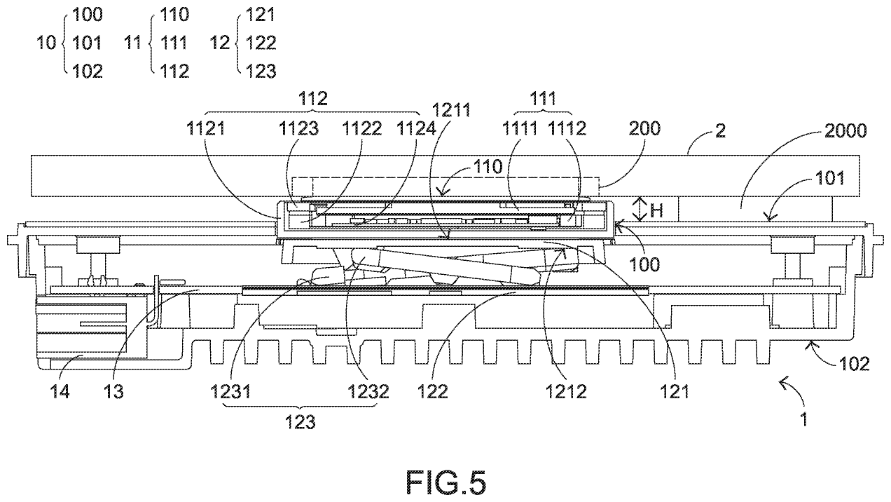

FIG. 5 is a schematic cross-sectional view illustrating a usage scenario of the wireless charging device according to the embodiment of the present invention. In this usage scenario, a to-be-charged electronic device 2 (e.g., a smart phone) with a magnetically attractable receiver coil structure 200 is intended to be charged by the wireless charging device 1.

For wirelessly charging the to-be-charged electronic device 2, the user moves the to-be-charged electronic device 2 to a position close to the wireless charging device 1. Meanwhile, a magnetic attractive force between the magnetically attractable transmitter coil structure 11 of the wireless charging device 1 and the magnetically attractable receiver coil structure 200 of the to-be-charged electronic device 2 is generated. Consequently, the magnetically attractable transmitter coil structure 11 of the wireless charging device 1 is moved upwardly through the lifting assembly 12. That is, since the magnetically attractable transmitter coil structure 11 is magnetically attracted by the magnetic attractive force, the outer frame 1231 and the inner frame 1232 of the lifting assembly 12 are correspondingly swung relative to each other. Consequently, the outer frame 1231 and the inner frame 1232 of the lifting assembly 12 are switched from a folded state to an open-scissors state. Moreover, while the magnetically attractable transmitter coil structure 11 is moved upwardly, a portion of the magnetically attractable transmitter coil structure 11 is moved outside the device body 100 through the hollow portion 100 of the device body 10. Consequently, the magnetically attractable transmitter coil structure 11 and the magnetically attractable receiver coil structure 200 of the to-be-charged electronic device 2 are attracted by and aligned with each other.

After the to-be-charged electronic device 2 with the magnetically attractable receiver coil structure 200 is departed from the wireless charging device 1, the magnetically attractable transmitter coil structure 11 and the magnetically attractable receiver coil structure 200 of the to-be-charged electronic device 2 are detached from each other. Meanwhile, the magnetically attractable transmitter coil structure 11 is moved downwardly through the lifting assembly 12. That is, after the magnetically attractable transmitter coil structure 11 is not magnetically attracted by the magnetic force, the magnetically attractable transmitter coil structure 11 and the lifting assembly 12 are moved in the direction of the gravity. As the outer frame 1231 and the inner frame 1232 of the lifting assembly 12 are correspondingly swung relative to each other, the outer frame 1231 and the inner frame 1232 of the lifting assembly 12 are switched from the open-scissors state to the folded state. While the magnetically attractable transmitter coil structure 11 is moved downwardly, the magnetically attractable transmitter coil structure 11 is moved into the inner portion of the device body 10 through the hollow portion 100 of the device body 10.

In this embodiment, the magnetically attractable transmitter coil structure 11 has a sensing plane 110. After the magnetically attractable transmitter coil structure 11 is moved upwardly through the lifting assembly 12 and moved outside the device body 10 through the hollow portion 100 of the device body 10, there is a height difference H between the sensing plane 110 of the magnetically attractable transmitter coil structure 11 and the upper member 101 of the device body 10. Whereas, after the magnetically attractable transmitter coil structure 11 is moved downwardly through the lifting assembly 12 and moved into the inner portion of the device body 10 through the hollow portion 100 of the device body 10, the sensing plane 110 of the magnetically attractable transmitter coil structure 11 and the upper member 101 of the device body 10 are coplanar with each other.

In an embodiment, the ascending distance of the magnetically attractable transmitter coil structure 11 matches the thickness of a lens module 2000 of the to-be-charged electronic device 2. That is, the height difference H between the sensing plane 110 of the magnetically attractable transmitter coil structure 11 and the upper member 101 of the device body 10 is approximately equal to the thickness of the lens module 2000 of the to-be-charged electronic device 2. Due to the structural design, the following benefits are achieved. When the magnetically attractable receiver coil structure 200 of the to-be-charged electronic device 2 and the magnetically attractable transmitter coil structure 11 of the wireless charging device 1 are attracted by and aligned with each other, the ascending distance of the magnetically attractable transmitter coil structure 11 matches the thickness of the lens module 2000. Consequently, the to-be-charged electronic device 2 is maintained in a horizontal placement state. It is noted that the ascending distance of the magnetically attractable transmitter coil structure 11 is not restricted. That is, the ascending distance of the magnetically attractable transmitter coil structure 11 may be determined according to the type of the to-be-charged electronic device 2. For example, in case that the thickness of the lens module 2000 is changed, the ascending distance of the magnetically attractable transmitter coil structure 11 is correspondingly adjusted.

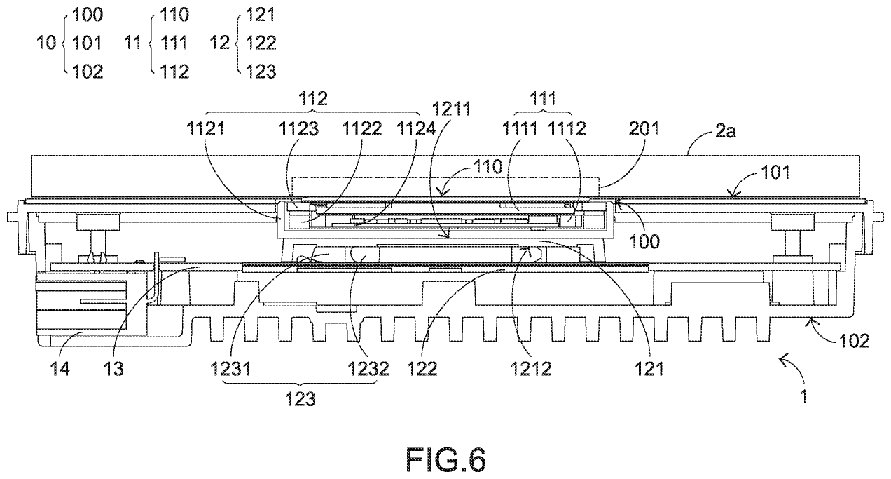

FIG. 6 is a schematic cross-sectional view illustrating another usage scenario of the wireless charging device according to the embodiment of the present invention. In this usage scenario, a general to-be-charged electronic device 2a with a general receiver coil structure 201 is intended to be charged by the wireless charging device 1. That is, the to-be-charged electronic device 2a is not equipped with the magnetically attractable receiver coil structure.

For wirelessly charging the to-be-charged electronic device 2a, the to-be-charged electronic device 2a is placed on the upper member 101 of the device body 10 of the wireless charging device 1. Since the magnetically attractable transmitter coil structure 11 is not attracted by a magnetic attractive force, the magnetically attractable transmitter coil structure 11 is not moved upwardly through the lifting assembly 12. However, the to-be-charged electronic device 2a on the upper member 101 of the device body 10 can still be charged by the wireless charging device 1.

From the above descriptions, the present invention provides the wireless charging device. The magnetically attractable transmitter coil structure of the wireless charging device can be moved upwardly or downwardly through the lifting assembly. Due to the structural design, the following benefits are achieved. When a to-be-charged electronic device with a magnetically attractable receiver coil structure is moved to a position close to the wireless charging device, the magnetically attractable transmitter coil structure of the wireless charging device is moved upwardly through the lifting assembly. Since the magnetically attractable transmitter coil structure of the wireless charging device and the magnetically attractable receiver coil structure of the to-be-charged electronic device are attracted by and aligned with each other, the charging efficiency is enhanced. In addition to the function of wirelessly charging the to-be-charged electronic device with the magnetically attractable receiver coil structure, the wireless charging device of the present invention has the function of wirelessly charging the to-be-charged electronic device with the general receiver coil structure. In other words, the wireless charging device of the present invention can be cooperatively used with many kinds of electronic devices. Consequently, the compatibility of the wireless charging device is enhanced.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A wireless charging device for charging a to-be-charged electronic device, the wireless charging device comprising:
a device body comprising an upper member, a lower member and a hollow portion, wherein the upper member and the lower member are opposed to each other, and the hollow portion is formed in the upper member;
a magnetically attractable transmitter coil structure disposed within the device body and aligned with the hollow portion; and
a lifting assembly disposed within the device body and located under the magnetically attractable transmitter coil structure, wherein the magnetically attractable transmitter coil structure is movable upwardly or downwardly relative to the device body through the lifting assembly,
wherein when the to-be-charged electronic device is moved to a position close to the wireless charging device, a magnetic attractive force between a magnetically attractable receiver coil structure of the to-be-charged electronic device and the magnetically attractable transmitter coil structure is generated, wherein in response to the magnetic attractive force, the magnetically attractable transmitter coil structure is moved upwardly through the lifting assembly, wherein as the magnetically attractable transmitter coil structure is moved upwardly, the magnetically attractable transmitter coil structure is moved outside the device body through the hollow portion, and the magnetically attractable transmitter coil structure and the magnetically attractable receiver coil structure of the to-be-charged electronic device are attracted by and aligned with each other.

2. The wireless charging device according to claim 1, wherein the magnetically attractable transmitter coil structure has a sensing plane, wherein after the magnetically attractable transmitter coil structure is moved upwardly through the lifting assembly and moved outside the device body through the hollow portion, there is a height difference between the sensing plane of the magnetically attractable transmitter coil structure and the upper member of the device body.

3. The wireless charging device according to claim 2, wherein after the to-be-charged electronic device is departed from the wireless charging device, the magnetically attractable transmitter coil structure and the magnetically attractable receiver coil structure are detached from each other, and the magnetically attractable transmitter coil structure is moved downwardly through the lifting assembly, wherein as the magnetically attractable transmitter coil structure is moved downwardly, the magnetically attractable transmitter coil structurer is moved into an inner portion of the device body through the hollow portion, and the sensing plane of the magnetically attractable transmitter coil structure and the upper member of the device body are coplanar with each other.

4. The wireless charging device according to claim 1, wherein the magnetically attractable transmitter coil structure comprises a transmitter coil module and a magnetic attraction module, and the magnetic attraction module is arranged around the transmitter coil module.

5. The wireless charging device according to claim 4, wherein the transmitter coil module comprises a transmitter coil unit and a first bracket, wherein the transmitter coil unit is installed on the first bracket.

6. The wireless charging device according to claim 4, wherein the magnetic attraction module comprises:
a second bracket;
a buffering pad installed on the second bracket;
a magnetic element installed on the buffering pad; and
a circuit board installed on the second bracket, wherein the buffering pad is arranged around the circuit board.

7. The wireless charging device according to claim 6, wherein the lifting assembly comprises:
a connection platform comprising a first surface and a second surface, wherein the first surface and the second surface are opposed to each other, and the connection platform is connected with the second bracket of the magnetic attraction module through the first surface;
a base plate located under the connection platform; and
a movable supporting element connected between the second surface of the connection platform and the base plate.

8. The wireless charging device according to claim 7, wherein the movable supporting element is a scissors-type supporting element.

9. The wireless charging device according to claim 1, wherein the wireless charging device further comprises a main board and a power input port, wherein the main board is disposed within the device body, the power input port is disposed within the device body, a portion of the power input port is exposed outside the device body, and the lifting assembly is arranged between the main board and the magnetically attractable transmitter coil structure, wherein the main board is electrically connected with the power input port and the magnetically attractable transmitter coil structure.
